(19) United States
(12) Patent Application Publication
(10) Pub. No.: US 2015/0238976 A1
(43) Pub. Date: Aug. 27, 2015

(54) Composition For Dressing Phosphate Ore

(71) Applicants: Clariant Finance (BVI) Limited, Tortola (VG); Clariant S.A., Sao Paulo (BR)

(72) Inventors: Wagner Claudio Da Silva, Sao Paulo (BR); Klaus Ulrich Pedain, Dietzenbach-Steinberg (DE); Nilson Mar Bartalini, Sao Paulo (BR); Zaira Guimaraes Duarte, Sao Paulo (BR); Monica Speck Cassola, Sao Paulo (BR); Jorge Antonio Arias Medina, Sao Paulo (BR); Antonio Pedro Oliveira Filho, Sao Paulo (BR)

(21) Appl. No.: 14/427,063

(22) PCT Filed: Aug. 20, 2013
(86) PCT No.: PCT/EP2013/002502

§ 371 Date: Mar. 10, 2015

(30) Foreign Application Priority Data
Sep. 13, 2012 (EP) 12006427.4

(51) Int. Cl. B03D 1/008; B03D 1/02

(52) U.S. Cl. CPC B03D 1/008; B03D 1/021; B03D 1/023; B03D 2203/06

(57) ABSTRACT

The invention relates to a flotation agent for phosphate ore, comprising at least one fatty acid and at least one sarcosinate of the formula (I)

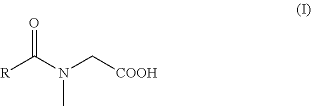

wherein R is a C₇ to C₂₁ alkyl or alkenyl group, which sarcosinate may be present in the form of a cation derived therefrom caused by protonation of the nitrogen atom, wherein the amount of fatty acid is from 70 to 99 wt.-%, and wherein the amount of the sarcosinate of the formula (I) is from 1 to 30 wt.-%.

This invention relates to the separation of phosphorus minerals such as apatite, phosphorite, francolite and the like by means of flotation from crude ores or preconcentrates using fatty acids as collecting agents and sarcosinates as co-collector.

Phosphorus minerals are found usually together with worthless gangue minerals, for example silicate minerals and carbonate minerals, such as calcite. The separation of the gangue minerals from phosphorous minerals is effected by flotation. Flotation usually requires a collector to be present.

According to Winnacker and Kuchler: Chemische Technologie [Chemical Technology], volume 4 (Metalle [Metals]), 4^{th} edition, Carl Hanser Verlag Munich, Vienna, 1986, page 66, collecting agents are organic-chemical compounds which, in addition to one or more non-polar hydrocarbon radicals, carry one or more chemically active polar groups which are capable of being adsorbed on active centers of the mineral and thus rendering the latter hydrophobic.

As is known, flotation or dressing by froth flotation is a widely used sorting process for mineral raw materials, in which one or more valuable minerals are separated from the worthless ones. The preparation of the mineral raw material for flotation is carried out by dry, but preferably wet grinding of the precomminuted ore to a suitable particle size which depends, on the one hand, on the degree of intergrowth, i.e. on the size of the individual particles in a mineral assemblage, and on the other hand also on the maximum particle size which is still possible to be floated and which can differ widely depending on the mineral. The type of flotation machine used also has an influence on the maximum particle size which is still possible to be floated. Though not the rule, it is frequently the case that the well crystallized magmatic phosphate ores allow coarser grinding (for example <0.25 mm) than those of marine-sedimentary origin (for example <0.15 mm). Further steps in preparing phosphate ore for flotation can represent a preseparation of worthless material on the one hand, for example by a heavy medium separation (separating off relatively coarse constituents), and on the other hand deslurrying (separating off slurries of the finest particles). The removal of magnetic minerals, which are almost always present in phosphate ores of magmatic origin, by means of magnetic separation is also a possible preconcentrating method. The invention is not restricted, however, to flotation processes preceded by any preconcentration.

With respect to the minerals to be recovered in the froth, two procedures must be distinguished. In direct flotation, the valuable mineral or minerals is or are collected in the froth which is generated on the surface of the flotation suspension, and this requires that their surfaces have previously been rendered hydrophobic by means of one or more collecting agents. The worthless minerals are then present in the flotation tailings. In inverse flotation, the worthless minerals are rendered hydrophobic by collecting agents, while the flotation tailings form the actual valuable concentrate. The present invention relates to the direct flotation of the phosphorus minerals, but it can also follow a preceding inverse flotation step which, for example, represents a flotation of silicate-type minerals by means of cationic collecting agents.

A large number of anionic and amphoteric chemical compounds are known as collecting agents for phosphorus minerals, and these include, for example, unsaturated fatty acids (oleic acid linoleic acid, linolenic acid) and the sodium, potassium or ammonium soaps thereof, monoalkyl and dialkyl phosphates, alkanesulfocarboxylic acids, alkylarylsulfonates, acylaminocarboxylic acids and alkylaminocarboxylic acids. In addition, collecting agents are known which are adducts of sulfosuccinic acid (see, for example U.S. Pat. No. 4,207,178, U.S. Pat. No. 4,192,739, U.S. Pat. No. 4,158,623 and U.S. Pat. No. 4,139,481). Many of these classes of chemical compounds, however, suffer from unsatisfactory selectivity which does not allow the production of saleable phosphate concentrations or makes it necessary to use a relatively large quantity of regulating reagents, especially depressants for the gangue minerals.

In the flotation of phosphate ore with fatty acids according to ZA-9009347, it is prior art that the flotation output can be improved by using, in addition to the collector (fatty acid), a dispersing agent, such as, for example, a nonyl phenol with 2-5 mol of ethylene oxide (EO) and an aliphatic alkoxylated alcohol with the chain length C₁₁-C₁₅ which contains 2-4 mol of EO. A further improvement arises if an alcohol with the chain length C₁-C₁₅ is dissolved in the dispersing agent. This alcohol improves the emulsifiability of the dispersing agent.

However, alkoxylated nonyl phenols are regarded to be questionable from the standpoint of environmental protection and toxicology. There is a tendency to avoid the use of alkoxylated nonyl phenols in flotation operations and to use a suitable replacement therefore.

The instant invention is therefore concerned with finding a replacement for alkoxylated nonyl phenols which are used as dispersing agents for the fatty acid collector in phosphate ore flotation. The replacement should be toxicologically acceptable and improve P₂O₅ recovery and grade.

Surprisingly, it has now been found that sarcosinates may be used as a replacement for alkoxylated nonyl phenols in said application. The sarcosinates will not act as dispersant but as a co-collector together with fatty acids, whereby the P₂O₅ recovery and grade are improved with respect to the use of alkoxylated nonyl phenols.

The invention thus provides a flotation agent for phosphate ore, comprising a collector composition which contains at least one fatty acid and at least one sarcosinate of the formula (I)

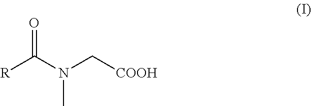

wherein R is a C₇ to C₂₁ alkyl or alkenyl group, which sarcosinate may be present in the form of a cation derived therefrom caused by protonation of the nitrogen atom.

The technical effect of the sarcosinate present in the flotation agent is that it is both a collector for phosphate ores and a dispersant. In the following, the expressions co collector or dispersant will relate to the sarcosinate. In formula (I), R is preferably a C₁₁ to C₁₉, more preferably a C₁₃ to C₁₇ residue. In a further preferred embodiment, R is an alkenyl residue having one double bond. The most preferred embodiment of formula (I) is oleyl sarcosinate, i.e. R is C₁₇ alkenyl.

The technical effect of the fatty acid present in the flotation agent is that it is a collector for phosphate ores. The fatty acid which makes up the main constituent of the flotation agent according to the invention is preferably a linear or branched monocarboxylic acid having 8 to 26 carbon atoms. For this purpose, the fatty acids known in the prior art as collectors can be used. The amount of fatty acid is 70 to 99, particularly 80 to 95, especially 85 to 90 wt.-% of the total flotation agent weight.

The flotation agent according to the invention comprises between 1 and 30%, particularly 5 to 20%, especially 10 to 15% by weight of the sarcosinate co-collector, based on the total flotation agent weight.

The flotation agent according to the invention is preferably used in amounts of from 100 to 1000 g/t of solid ore for the flotation of phosphate ores. The amount of co-collector agent according to the invention added in the case of separate collector dosing is preferably between 30 and 150 g/t, in particular between 40 and 60 g/t of solid ore.

The flotation agent according to the invention can, in addition to said constituents of fatty acid and sarcosinate, comprise depressants or further constituents known from the prior art. Such constituents are, for example, foaming agents and aliphatic polyglycol ethers. In addition, different depressants such as, for example, waterglass, caustic starch can be used separately.

Another aspect of this invention is the use of at least one fatty acid and at least one compound of formula (I) in admixture as flotation agents for phosphate ores.

Another aspect of this invention is a process for flotating phosphate ores, the process comprising the step of adding the flotation reagent comprising at least one fatty acid and at least one compound of formula (I) to an aqueous suspension of the ore, and aerating the so obtained mixture.

### EXAMPLES

### Collector Formulation Preparation

Crude soy oil fatty acid was heated to around 50° C. until all solids are molten, and is subsequently homogenized. 85 g of the homogenized crude soy oil fatty acid was transferred to a beaker at 25° C. and (under stirring at around 100 rpm) 15 g of oleyl sarcosinate was added slowly, and the mixture was homogenized for 30 minutes.

Applications-Related Investigations

Froth flotation experiments were conducted using a Denver laboratory flotation cell. 0.85 kg of ground ore was conditioned by stirring at 1100 rpm with 0.6 liters of water (solids content of the pulp 60 wt-%). A depressant (maize corn caustic starch), the above described collector and 150 g of recycling concentrate (cleaner tailing) were added and conditioning continued for 5 minutes thereafter. The solids content of the pulp was adjusted to 30% by adding water. The pH was adjusted to 9.5 and the mixture was stirred for 1 minute.

The air intake was opened and the ore was floated during 3 minutes, obtaining the rougher concentrate (froth) and rougher tailing (remaining ore in the cell). The rougher concentrate was returned to the flotation cell and was floated again without adding collector for 2 minutes at 1100 rpm, obtaining the clean concentrate (phosphate concentrate) and cleaner tailing. The clean concentrate and cleaner tailing, besides the rougher tailing (final tailing dried at 105±5° C.), were weighed and analysed to determine their magnesium oxide and calcium oxide grade.

Materials used:

Dispersant 1=Oleyl sarcosinate (Clariant S/A)

Dispersant 2=Nonyl phenol ethoxylate (Clariant S/A) (comparative)

Fatty acid=Crude soy oil fatty acid (Almad S/A)

### Example 1

The efficiency of pure Fatty acid (composition 1) was compared to composition 2 which is a mixture of fatty acid and Dispersant 1 in the indicated weight ratio. The concentration of fatty acid can be reduced, relative to the comparison product, from 100% to 75% thereby improving the recovery and keeping the P₂O₅ in acceptable grade. P₂O₅ in acceptable grade means a target of ≧35.8 weight-% P₂O₅.

TABLE 1
Composition and flotation results for phosphate ore (Pilha 1585).

| | | | | grade | Recovery |
|---|---|---|---|---|---|
| | Formulation (wt.-%) | | Dosage | P₂O₅ | P₂O₅ |
| Composition | Fatty acid | Dispersant 1 | (g/t) | (wt.-%) | (wt.-%) |
| 1 (comp.) | 100 | 0 | 150 | 33.11 | 37.20 |
| | 100 | 0 | 200 | 33.04 | 61.00 |
| | 100 | 0 | 250 | 32.67 | 71.16 |
| 2 | 75 | 25 | 150 | 37.84 | 86.61 |
| | 75 | 25 | 200 | 36.36 | 92.87 |
| | 75 | 25 | 250 | 35.80 | 96.56 |

### Example 2

The efficiency of a conventional dispersing agent and co-collector (Dispersant 2) was compared to the dispersing agent and co-collector (Dispersant 1) according to the invention. Use of the dispersing agent and co-collector (Dispersant 1) according to the invention (composition 7, 8 and 9) increase the phosphate recovery is achieved besides keeping the P₂O₅ in acceptable grade (Target ≧35.8 wt.-% P₂O₅).

TABLE 2
Composition and flotation results for phosphate ore (Pilha 1585).

| | Formulation (wt.-%) | | | | | Recovery |
|---|---|---|---|---|---|---|
| Composi- | Fatty | Dispersant | Dispersant | Dosage | P₂O₅ | P₂O₅ |
| tion | acid | 2 | 1 | (g/t) | (wt.-%) | (wt.-%) |
| 3 | 0 | 100 | 0 | 200 | n.a. | n.a. |
| 4 | 0 | 0 | 100 | 200 | 28.66 | 96.05 |
| 5 | 100 | 0 | 0 | 200 | 33.04 | 61.00 |
| 6 | 75 | 25 | 0 | 200 | 36.36 | 92.87 |
| 7 | 85 | 0 | 15 | 200 | 36.87 | 90.58 |
| 8 | 88.5 | 0 | 17.5 | 200 | 36.48 | 91.24 |
| 9 | 80 | 0 | 20 | 200 | 36.33 | 92.74 |

*n.a. means that there was no flotation observed
All percentages herein mean wt.-% if not indicated otherwise.

1. A flotation agent for phosphate ore, comprising at least one fatty acid and at least one sarcosinate of the formula (I) 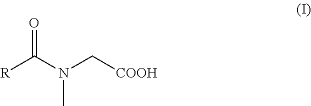
wherein R is a C₇ to C₂₁ alkyl or alkenyl group, wherein the sarcosinate may be present in the form of a cation derived therefrom, caused by protonation of the nitrogen atom, wherein the amount of fatty acid is from 80 to 99 wt.-%, and wherein the amount of the sarcosinate of the formula (I) is from 1 to 20 wt.-%.

2. The flotation agent as claimed in claim 1, wherein the fatty acid has from 8 to 26 carbon atoms.

3. The flotation agent as claimed in claim 1, wherein R is a C₁₁ to C₁₉ residue.

4. (canceled)

5. A process for flotating a phosphate ore, the process comprising the step of adding from 100 to 1000 g/t of the flotation agent as claimed in claim 1 to an aqueous suspension of the phosphate ore to form a mixture, and subsequently aerating the mixture.

6. The flotation agent as claimed in claim 2, wherein R is a C₁₁ to C₁₉ residue.

7. A process for flotating a phosphate ore, the process comprising the step of adding from 100 to 1000 g/t of the flotation agent as claimed in claim 2 to an aqueous suspension of the phosphate ore to form a mixture, and subsequently aerating the mixture.

8. A process for flotating a phosphate ore, the process comprising the step of adding from 100 to 1000 g/t of the flotation agent as claimed in claim 3 to an aqueous suspension of the phosphate ore to form a mixture, and subsequently aerating the mixture.
